(19) United States
(12) Patent Application Publication
(10) Pub. No.: US 2011/0023721 A1
(43) Pub. Date: Feb. 3, 2011

(54) AIR FILTRATION DEVICE

(75) Inventors: Rod Tanis, Hudsonville, MI (US); Casey Prins, Hamilton, MI (US)

Correspondence Address: MILLER, CANFIELD, PADDOCK AND STONE;ROBERT K. ROTH, ESQ., 150 W. JEFFERSON, SUITE 2500, DETROIT, MI, 48226, US

(73) Assignee: Tanis Technologies, L.L.C., Holland, MI (US)

(21) Appl. No.: 12/511,150

(22) Filed: Jul. 29, 2009

(51) Int. Cl. F24F 7/06; B01D 46/00

(52) U.S. Cl. 96/380; 55/385.1

(57) ABSTRACT

An air filtration device comprises a housing assembly having at least one first mounting surface and having at least one air outlet, a blower positioned in the housing assembly for blowing air towards the at least one outlet, and a motor for driving the blower. At least one air intake has at least two intake mounting surfaces which are the same as each other and the same as the first mounting surface, wherein the air intake is attached to the housing assembly at one of the first mounting surfaces. At least one of the two intake mounting surfaces is positioned at an acute angle with respect to the other of the two intake mounting surfaces. Also, a muffler can be positioned adjacent the at least one air outlet. The muffler defines an opening operatively connected to the air outlet and the opening has a first cavity having a first volume, a second cavity having a second volume, and a third cavity having a third volume. The second cavity is between the first cavity and the third cavity, and the second volume is greater than both the first volume and the third volume.

### FIELD OF THE INVENTION

This invention relates to improvements in air filtration devices, and more particularly to improvements in air filtration devices used in manufacturing facilities.

### BACKGROUND OF THE INVENTION

Air filtration devices are used in manufacturing centers and other places where air needs to be cleaned, i.e., removed of air contaminants such as dust, smoke, odors, chemical vapors and the like. Such devices, when used in manufacturing centers, can positively effect employee morale, comfort and productivity. In manufacturing centers, such air filtration devices are also sometimes referred to as air makeup systems, as they help adjust air pressure to maintain positive or negative pressure in a selected volume. The name comes from the fact that for every cubic foot of air removed from a building must be replaced with the same amount. If the air was not replaced this could cause negative pressure in the building and could potentially cause collapse if the air removed was not replaced. Most air makeup units are mounted on the roof of the building. One example is the exhaust fan on a spray booth. This operation takes large amounts of air out of the building, and the air must be made up.

Air filtration devices are used where fresh air needs to be continuously introduced to a volume. In larger volumes, the effectiveness of such air filtration devices may vary significantly depending upon location. Generally the air filtration device should be positioned as close as possible to the source of air contamination, as that helps the device catch and remove as much of the undesirable contaminants as possible while still relatively concentrated. With a mis-positioned air filtration device, undesirable vagrant draft conditions may arise.

In addition to location issues, known air filtration devices can be unacceptably noisy. It would be highly desirable to provide an air filtration device which is relatively quiet and which can reduce problems with location.

### SUMMARY OF THE INVENTION

In accordance with a first aspect, an air filtration device comprises a housing assembly having at least one first mounting surface and having at least one air outlet, a blower positioned in the housing assembly for blowing air towards the at least one outlet, and a motor for driving the blower. At least one air intake has at least two intake mounting surfaces which are the same as each other and the same as the first mounting surface, wherein the air intake is attached to the housing assembly at one of the first mounting surfaces. At least one of the two intake mounting surfaces is positioned at an acute angle with respect to the other of the two intake mounting surfaces. In accordance with another aspect, a muffler can be positioned adjacent the at least one air outlet. The muffler defines an opening operatively connected to the air outlet and the opening has a first cavity having a first volume, a second cavity having a second volume, and a third cavity having a third volume. The second cavity is between the first cavity and the third cavity, and the second volume is greater than both the first volume and the third volume.

From the foregoing disclosure and the following more detailed description of various preferred embodiments it will be apparent to those skilled in the art that the present invention provides a significant advance in the technology of air filtration devices. Particularly significant in this regard is the potential the invention affords for providing a high quality, low cost air filtration device which can be mounted in a variety of geometries and thereby account for irregular surfaces. Additional features and advantages of various preferred embodiments will be better understood in view of the detailed description provided below.

### BRIEF DESCRIPTION OF THE DRAWINGS

FIG. 1 is an exploded view of an air filtration device in accordance with one embodiment.

FIGS. 2-4 show various embodiments of the air filtration device using angled intakes for adjusting position of an air inlet.

FIG. 5 is an isolated view of an air intake.

FIG. 6 is an exploded view of the main housing assembly.

FIG. 7 is an exploded view of the main housing assembly, showing a blower and a motor driving the blower.

FIG. 8 is an isometric, assembled view of the main housing assembly.

FIG. 9 is another assembled view of the main housing assembly, showing sound reducing elements.

FIG. 10 is a side view of the blower and the motor which drives the blower.

FIG. 11 is an isolated isometric view of the muffler.

FIG. 12 is cut-away view of the muffler, showing the irregular internal volumes of the muffler.

FIG. 13 is a cut-away view of the muffler, showing a muffler screen and muffler wire.

FIG. 14 is another cut-away view of the muffler, showing air flow patterns.

It should be understood that the appended drawings are not necessarily to scale, presenting a somewhat simplified representation of various preferred features illustrative of the basic principles of the invention. The specific design features of the air filtration device as disclosed here, including, for example, the specific dimensions of the air intakes, will be determined in part by the particular intended application and use environment. Certain features of the illustrated embodiments have been enlarged or distorted relative to others to enhance visualization and clear understanding. In particular, thin features may be thickened, for example, for clarity of illustration. All references to direction and position, unless otherwise indicated, refer to the orientation illustrated in the drawings.

### DETAILED DESCRIPTION OF CERTAIN EMBODIMENTS

It will be apparent to those skilled in the art, that is, to those who have knowledge or experience in this area of technology, that many uses and design variations are possible for the air filtration device disclosed here. The following detailed discussion of various alternative features and embodiments will illustrate the general principles of the invention with reference to an air filtration device useful in a manufacturing center to filter and recycle air within the center. Other embodiments suitable for other applications will be apparent to those skilled in the art given the benefit of this disclosure.

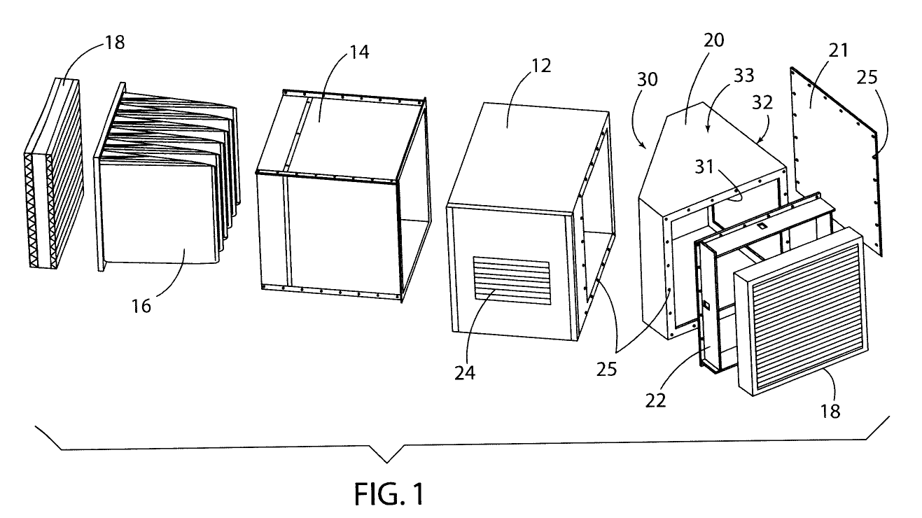

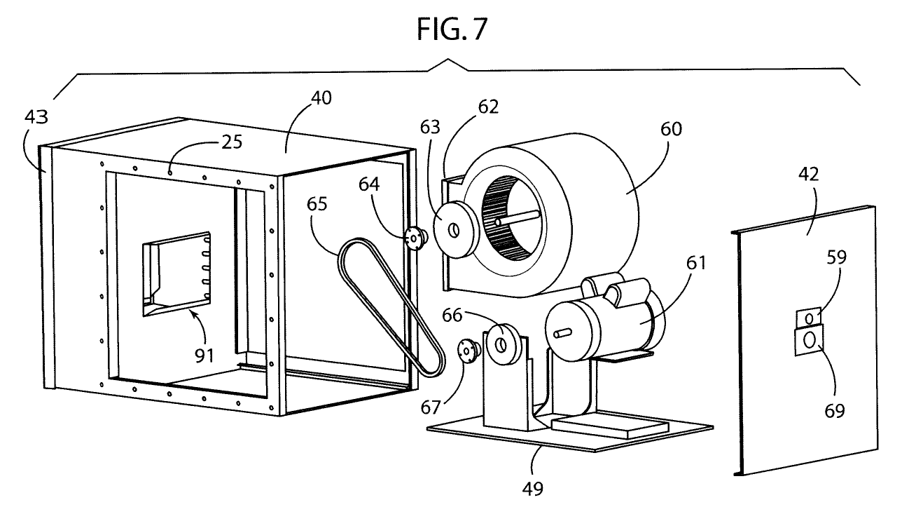

Referring now to the drawings, FIG. 1 shows an exploded isometric view of an air filtration device 10 in accordance with one embodiment wherein a housing assembly 12 has an air outlet or exhaust 24, and at least one first mounting surface 25. In the embodiment shown in FIG. 1, housing assembly 12 has a pair of first mounting surfaces, one visible, and one on the opposite side of the housing assembly adjacent straight air intake 14. A blower and a motor for driving the blower (shown below at FIG. 7) are positioned in the housing assembly. The blower blows air towards the outlet(s).

FIG. 1 shows a pre-filter 18 used in combination with a filter 16 mounted to air intake 14. The pre-filter 18 is relatively cheap and easy to replace. Pre-filter 18 is a pleated filter that catches the majority of the large contaminants before they are pulled into the bag filter 16. Bag filters 16 are generally much more expensive than pleated filters. Thus use of a pre-filter 18 can significantly extend the life of the bag filters, where used. Other filters and combinations of filters may also be used on both straight air intakes 14 and on the angled air intakes 20. For example, a single filter may be attached to an air intake with air filter attachment plate 22 adjacent an air intake mounting surface 25 and remote from the housing assembly, i.e., at the air intake mounting surface not directly connected to the housing assembly.

In accordance with a highly advantageous feature, air intake 20 has at least two air intake mounting surfaces, thereby allowing for attachment to the housing assembly and to each other at a variety of angles. This allows the position of the air intake to be changed and located at the most useful location. In the embodiment of FIG. 1, air intake 20 has side walls 33, and defines openings 30, 31 and 32. The interior of the air intake is hollow, and any and all openings are connected together. Each of the openings is surrounded by a corresponding air intake mounting surface 25. One of the openings, along with its corresponding intake mounting surface is positioned at an acute angle with respect to the other two openings (and the corresponding air intake mounting surfaces). Here, the angle is about 45 degrees. Opening 32 is shown here closed off with a plate 25 and the plate 25 has a mounting surface 25 which is the same as the mounting surfaces on both the intakes and the housing assembly. The term “same” is understood here to mean that each mounting surface can be interchangeably attached to any other mounting surface. One way to do that is as shown, with a common pattern of holes for fasteners connecting the air intake to the housing assembly, to another air intake, two housing assemblies, or just to a plate to close off one of the openings, as needed. As shown, each of the first mounting surfaces and the intake mounting surfaces form a square perimeter having the same area, with the pattern of holes formed around the perimeter. Making the first mounting surfaces 25 on the housing assembly 12 the same as the air intake mounting surfaces 25 on the air intakes is highly advantageous as it allows for modular construction with a wide variety of final designs.

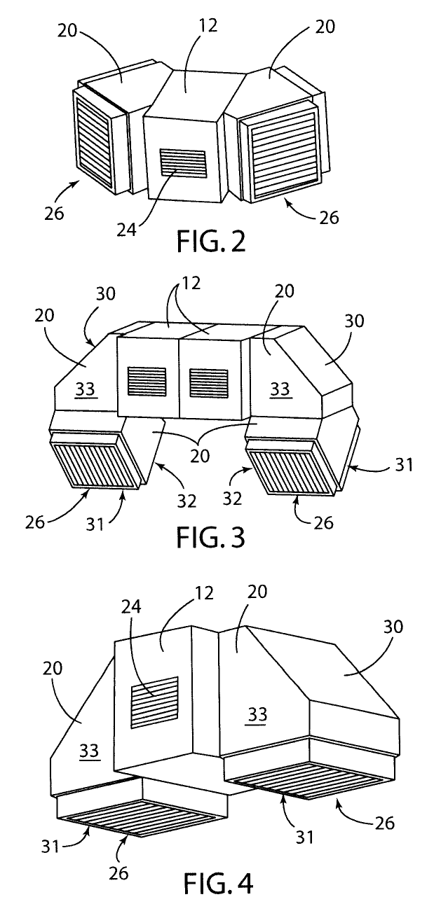

FIGS. 2-4 show several optional final designs for an air filtration device in accordance with the invention. FIG. 2 shows a single housing assembly with two air intakes 20, with each air intake attached to a first mounting surface. As is clearly shown in FIG. 2, the air intake mounting surface attached to the first mounting surface is the one formed at an acute angle with respect to one of the other air intake surfaces. Air inlets 26 allow air into the air filtration device. Air is expelled through air outlet 24. FIG. 3 shows two housing assemblies 12 connected together at first mounting surfaces, and four air intakes 20 connected together as shown (first to third, and second to fourth). FIG. 4 shows another embodiment where air intakes 20 are attached to the housing assembly at one of the openings (here 32) which forms a right angle with another opening (31). The air intake 20 comprises a first air intake 20 and a second air intake 20, with each air intake having at least two intake mounting surfaces. The housing assembly comprises a pair of first mounting surfaces, with the first air intake attached to one of the first mounting surfaces at one the intake mounting surfaces and the second air intake is attached to another one of the first mounting surfaces at another one of the intake mounting surfaces. Additional combinations of housing assemblies 12 and air intakes 20 will be readily apparent to those skilled in the art given the benefit of this disclosure.

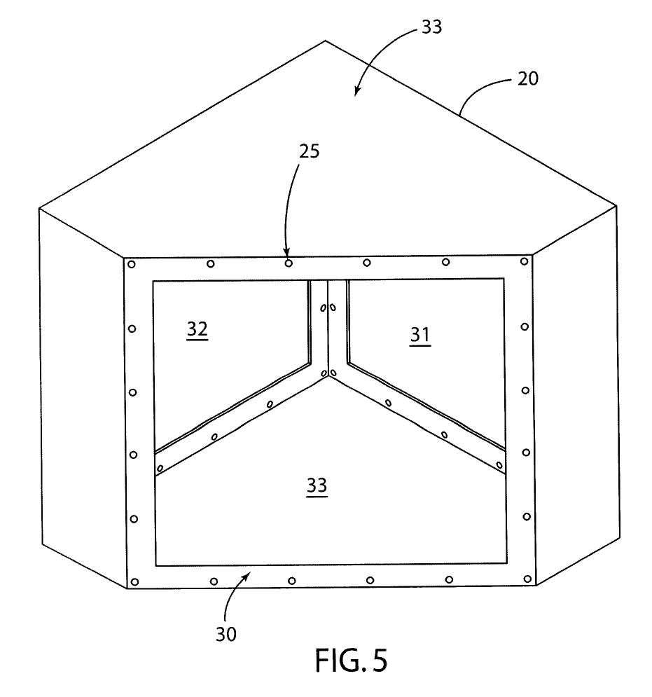

FIG. 5 is an isolated view of a representative air intake 20. Side walls 33 are closed off, and openings 30, 31, 32, each with a corresponding air intake mounting surface 25, are provided. Air intake opening 30 is formed at an acute angle with air intake opening 31 (and 32), and 31 is at right angles with respect to 32. This orientation cleverly allows for a wide variety of assembly configurations for the air filtration device.

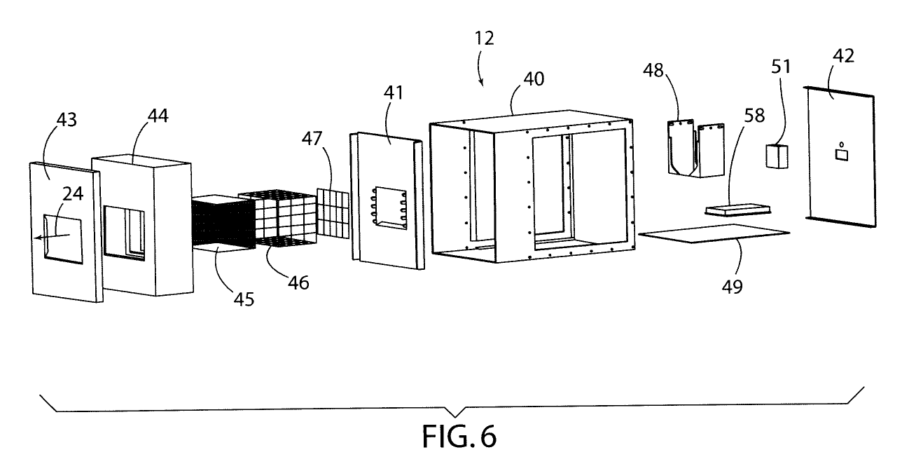

FIGS. 6-14 show another advantageous feature of the air filtration device. A muffler 44 is positioned at main housing front 43 adjacent the air outlet 24. Preferably the muffler comprises a cellulose material. A muffler screen 45 and muffler wire 46 are also provided. The main purpose of the muffler screen 45 is to prevent small cellulose particles from being blown out of the device at the outlet 4. The muffler wire 46 serves to help hold the shape of a silencer tunnel or opening 91 (shown in FIGS. 7-9 and discussed in further detail below), and the muffler wire 46 further interrupts and breaks up lower velocity air current causing the air to make contact with the cellulose material.

Finger guard 47 prevents hands from accessing the blower. The muffler 44 may be mounted on a muffler plate 41, which is in turn attached to a housing assembly frame 40. Other components of the housing assembly are a blower mount 48, an adjustable motor bracket 58 and a motor blower base 49. A main housing back 42 may be provided with an electrical box 51, adapted to provide electricity to the air filtration device. The housing assembly advantageously allows for simple maintenance, as the back 42 is removable with a few screws or fasteners to allow easy access to the motor and to the blower. In accordance with one option, once the back 42 has been removed along with two bolts from the motor blower base 49, the base 49 may be slid out of the back of the main housing assembly frame 40.

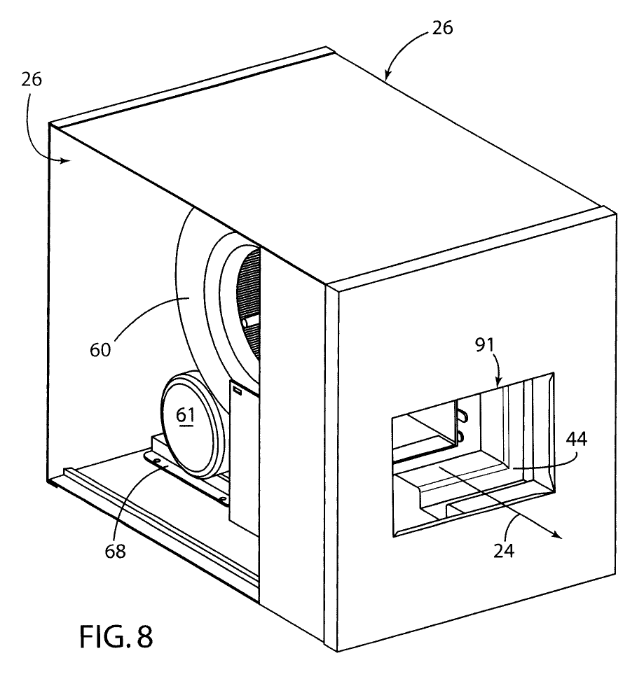

FIG. 7 shows an exploded isometric view of one embodiment of a blower 60 and a motor 61 for use in the air filtration devices disclosed herein. The motor can comprise, for example, a 110V motor connected to an inlet plug 69 and circuit breaker 59 mounted on back 42. The motor and blower are positioned in an interior 41 of assembly frame 40 of the housing assembly 12. Blower 60 has a seal 62. Pulleys 63, 66 and bushings 64, 67 are operatively connected by a drive belt 65. FIG. 8 is an assembled view from the front of the housing assembly. Rotation of the motor 61 rotates the blower 60, forcing air through the opening 91 in the muffler and out of the outlet 24.

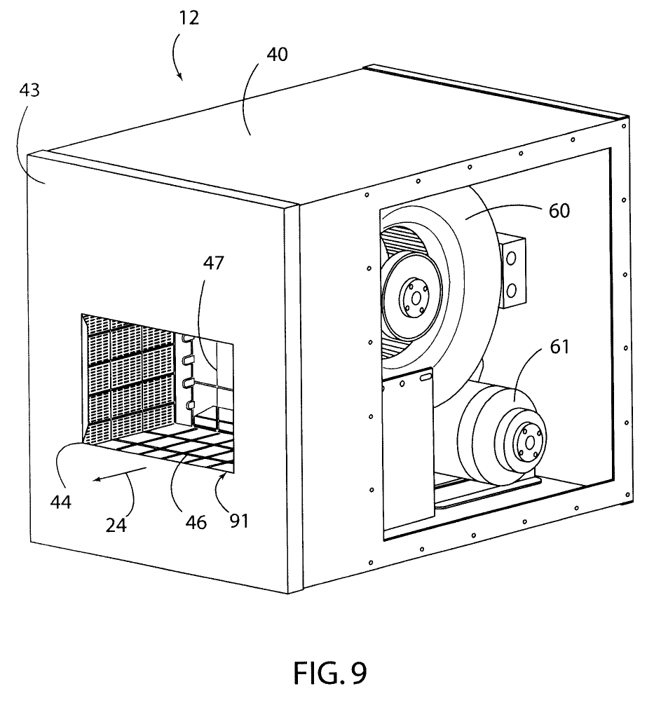

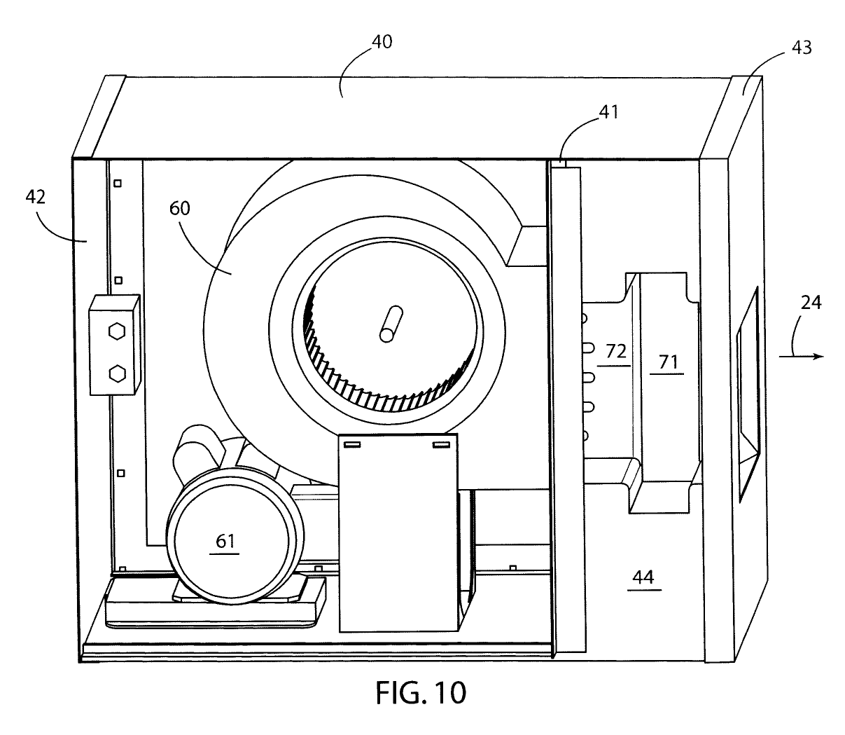

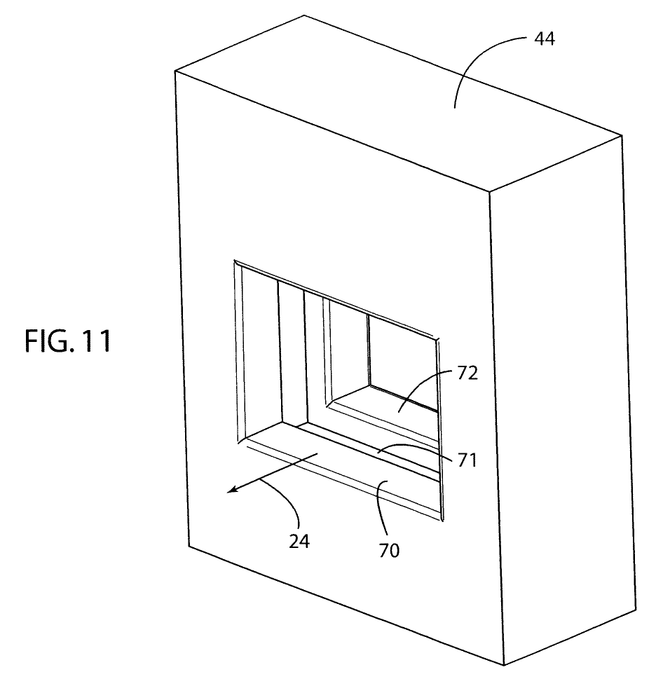

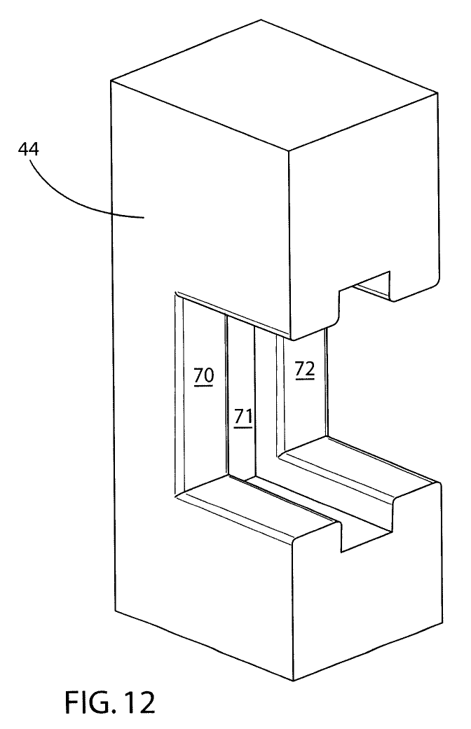

FIG. 9 shows the housing assembly with the muffler screen 45 and muffler wire 46 in assembled position, along with the finger guard 47 all positioned around opening 91. FIG. 10 is a side view of the housing assembly which shows two 71, 72 of at least three optionally rectangular cavities provided in the muffler 44. FIG. 11 is an isolated view of the muffler of 44 with the muffler defining the opening 91 operatively connected to the air outlet 24. The opening 91 has a first cavity 70 having a first volume, a second cavity 71 having a second volume, and a third cavity 72 having a third volume, wherein the second cavity is between the first cavity and the third cavity, and the second volume is greater than both the first volume and the third volume. FIG. 12 is a slide through the muffler allowing a better view of the three cavities. Air travels through an irregular path on its way to the outlet, over a larger surface area of sound absorbing muffler. It has been found that such a serpentine passageway or opening helps reduce noise by about 20 dB over known air filtration devices for use in manufacturing centers.

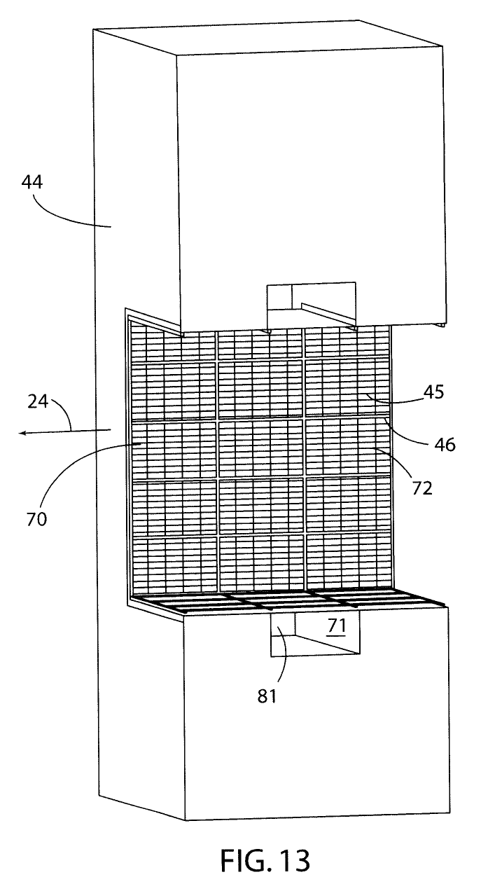

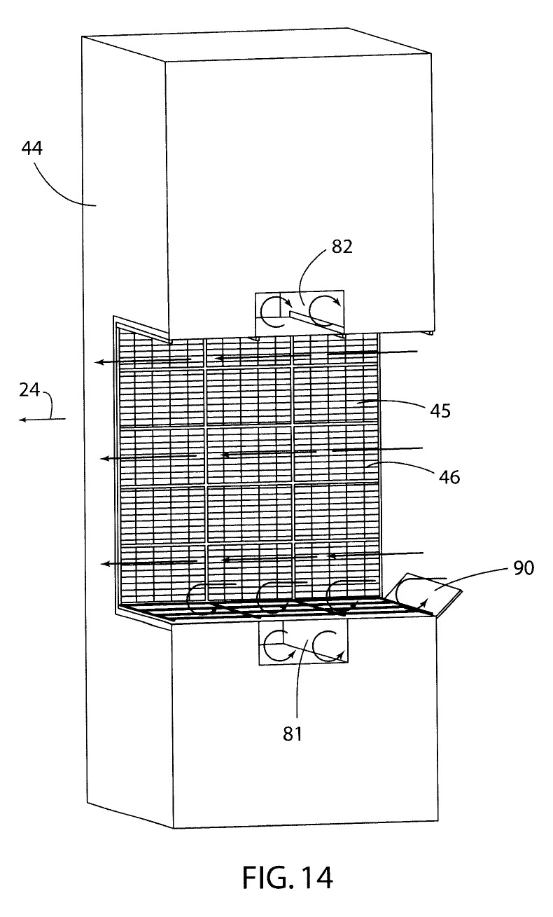

FIGS. 13-14 show the muffler screen 45 and muffler wire 46 in assembled position in the opening 91 against the muffler 44. Volumes 81 and 82 are the extra volume of the second cavity 71. A spoiler 90 is also provided. As the air enters the silencer tunnel or opening it impacts the spoiler; this initial contact causes the air to roll. The rear of that same spoiler draws the air stream down causing a vacuum. The air stream advances on rolling through the silencer tunnel, as shown by arrows in FIG. 14, impacting the muffler wire 46. The muffler wire 46 breaks up the lower velocity rolling air enabling it to contact the cellulose material of the muffler and thereby absorb sound. This air flow can occur on all four walls of the silencer simultaneously. Since the low pressure air flow is continuously forming a natural air stream barrier it allows the high velocity air stream in the center of the tunnel to flow without impact resulting in a greatly reduced sound pressure reading or decibel reading.

The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. An air filtration device comprising, in combination:
a housing assembly having at least one first mounting surface and having at least one air outlet;
a blower positioned in the housing assembly for blowing air towards the at least one outlet, and a motor for driving the blower;
at least one air intake having at least two intake mounting surfaces which are the same as each other and the same as the at least one first mounting surface, wherein the at least one air intake is attached to the housing assembly at one of the at least one first mounting surfaces; and
at least one of the two intake mounting surfaces is positioned at an acute angle with respect to the other of the two intake mounting surfaces.

2. The air filtration device of claim 1 wherein the at least one air intake has three intake mounting surfaces, and one of the three intake mounting surfaces is positioned at an acute angle with respect to the other of the intake mounting surfaces.

3. The air filtration device of claim 2 wherein two of the intake mounting surfaces are positioned at a right angle with respect to each other.

4. The air filtration device of claim 1, wherein the at least one first mounting surface and the at least two intake mounting surfaces each define a pattern of holes adapted to receive fasteners connecting the at least one air intake to the housing assembly.

5. The air filtration device of claim 4 wherein the at least one first mounting surface and the at least two intake mounting surfaces each form a square perimeter having the same area, and the pattern of holes is positioned on each square perimeter.

6. The air filtration device of claim 1 wherein the at least one air intake comprises a first air intake and a second air intake, with each air intake having at least two intake mounting surfaces, and the at least one first mounting surface comprises a pair of first mounting surfaces, with the first air intake attached to one of the first mounting surfaces at one of the at least two intake mounting surfaces, and the second air intake attached to another one of the first mounting surfaces at one of the at least two intake mounting surfaces.

7. The air filtration device of claim 6 further comprising a third air intake attached to the first air intake, and a fourth air intake attached to the second air intake.

8. The air filtration device of claim 1 further comprising an air filter attached adjacent to one of the at least two air intake mounting surfaces.

9. The air filtration device of claim 8 wherein the one of the at least two air intake mounting surfaces with the air filter attached adjacent is remote from the housing assembly.

10. The air filtration device of claim 1 further comprising:
a muffler positioned adjacent the at least one air outlet, the muffler defining an opening operatively connected to the at least one air outlet, the opening having a first cavity having a first volume, a second cavity having a second volume, and a third cavity having a third volume, wherein the second cavity is between the first cavity and the third cavity, and the second volume is greater than both the first volume and the third volume.

11. An air filtration device comprising, in combination:
a housing assembly having at least one first mounting surface and having at least one air outlet;
a blower positioned in the housing assembly for blowing air towards the at least one outlet, and a motor for driving the blower;
a muffler positioned adjacent the at least one air outlet, the muffler defining an opening operatively connected to the at least one air outlet, the opening having a first cavity having a first volume, a second cavity having a second volume, and a third cavity having a third volume, wherein the second cavity is between the first cavity and the third cavity, and the second volume is greater than both the first volume and the third volume.

12. The air filtration device of claim 11 wherein the first cavity, second cavity and third cavity are rectangular in shape.

13. The air filtration device of claim 11 wherein the muffler comprises a cellulose material.
